(19) United States
(12) Patent Application Publication
(10) Pub. No.: US 2007/0007366 A1
(43) Pub. Date: Jan. 11, 2007

(54) Method for producing and fixing a perforated disk

(76) Inventors: Markus Gesk, Karlsbad (DE); Martin Maier, Moeglingen (DE)

Correspondence Address: KENYON & KENYON LLP, ONE BROADWAY, NEW YORK, NY, 10004, US

(21) Appl. No.: 10/552,281

(22) PCT Filed: Feb. 4, 2004
(86) PCT No.: PCT/DE04/00178

§ 371 Date: Jul. 12, 2006

(30) Foreign Application Priority Data
Apr. 1, 2003 (DE) 10314670.9

(51) Int. Cl. F02M 47/02; B05B 1/34; F02M 63/00; B05B 1/30

(52) U.S. Cl. 239/533.14; 239/88; 239/89; 239/533.2

(57) ABSTRACT

The method for producing and securing an apertured disk for a fuel injector is distinguished by the use of the following method steps: a) making available a flat, metallic sheet having a constant thickness, b) reducing the thickness in one region of the sheet by impressing or embossing, c) introducing at least one spray-discharge opening in the region having reduced thickness, d) machining the sheet until an apertured disk having predefined outside dimensions is attained, and e) securing the apertured disk on a valve-seat member of the fuel injector in such a way that a lower end face of the valve-seat member overlaps an intake region of the apertured disk produced by the thickness reduction, such that the at least one spray-discharge opening is covered.

### BACKGROUND INFORMATION

German Patent Application No. DE 41 21 310 describes a fuel injector which has a valve-seat member, on which a fixed valve seat is formed. A valve-closure member, which is axially movable in the injector, cooperates with this valve seat formed in the valve-seat member. Adjoining the valve-seat member in the downstream direction is a flat jet-directional plate in which, facing the valve seat, an H-shaped depression is provided as an intake region. Adjoining the H-shaped intake region in the downstream direction are four spray-discharge orifices, so that a fuel to be discharged can be distributed over the intake region toward the spray-discharge orifices. In so doing, the flow geometry in the jet-directional plate is not to be influenced by the valve-seat member. Rather, a flow passage is implemented downstream of the valve seat in the valve-seat member so far that the valve-seat member has no influence on the opening geometry of the jet-directional plate.

### SUMMARY OF THE INVENTION

The method of the present invention for producing and securing an apertured disk has the advantage that particularly small apertured-disk thicknesses are easily attainable. Since according to the present invention, the spray-discharge openings are introduced in the thickness-reduced middle region of the apertured disk, it is possible to form a plurality of spray-discharge openings having very small spray-orifice diameters in the apertured disk, while maintaining known and customary ratios of length to diameter of each individual spray-discharge opening. Consequently, an apertured disk produced according to the present invention and mounted on a fuel injector guarantees the finest uniform atomization of the fuel, a particularly high atomization quality and a jet formation adapted to the specific requirements being attained.

The impressing or embossing process employed for reducing the thickness of the apertured disk may advantageously be used with low expenditure for forming apertured disks in very large quantities.

In particularly advantageous manner, the apertured disk produced according to the present invention is mounted in such a way on a fuel injector that the apertured disk, disposed downstream of a valve seat, has an opening geometry for a complete axial passage of the fuel, the opening geometry being bounded by a valve-seat member encompassing the fixed valve seat. The valve-seat member therefore already assumes the function of influencing the flow in the apertured disk. An S-twist is especially advantageously attained in the flow for improving the fuel atomization, since a lower end face of the valve-seat member covers the spray-discharge openings in the apertured disk.

The S-twist in the flow, attained by the geometrical arrangement of the valve-seat member and the apertured disk, allows the formation of bizarre jet forms having high atomization quality. The apertured disks, in conjunction with suitably implemented valve-seat members for single-jet, dual-jet and multi-jet sprays, permit jet cross-sections in countless variants. Using such a fuel injector, it is possible to reduce the exhaust emissions of the internal combustion engine, and fuel consumption is able to be reduced as well.

### BRIEF DESCRIPTION OF THE DRAWINGS

FIG. 1 shows a partially depicted injector having an apertured disk downstream of the valve-seat member.

FIG. 2 shows an enlarged representation of the valve-seat part made up of the valve-seat member and apertured disk.

FIG. 3 shows schematically the method step of impressing or embossing.

### DETAILED DESCRIPTION

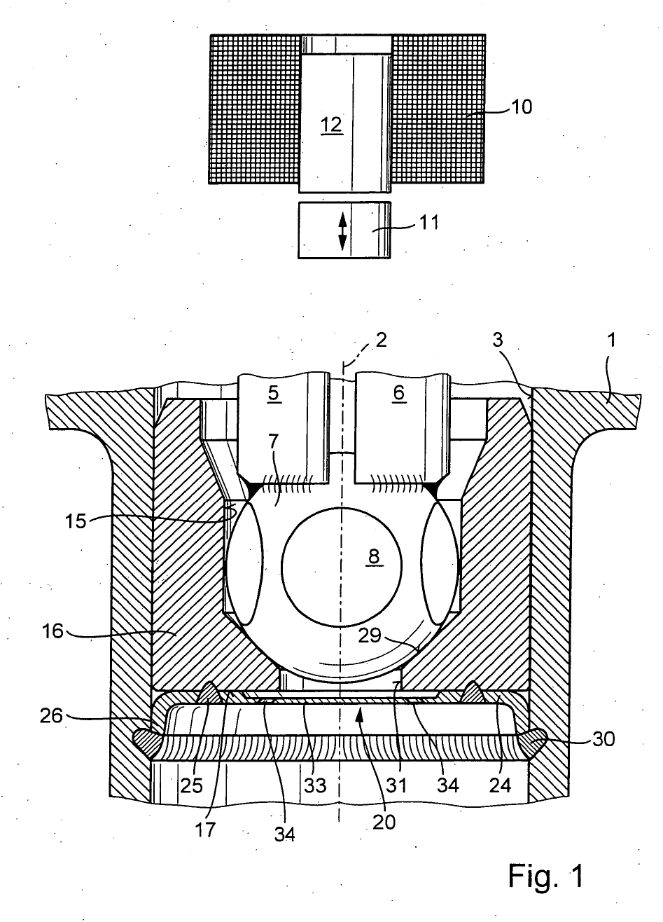

FIG. 1 partially shows a valve in the form of an injector for fuel injection systems of mixture-compressing internal combustion engines having externally supplied ignition. The injector has a tubular valve-seat support 1, in which a longitudinal opening 3 is formed concentrically with respect to a longitudinal valve axis 2. Situated in longitudinal opening 3 is a, for example, tubular valve needle 5, which is securely joined at its downstream end 6 to a, for instance, spherical valve closure member 7, at whose periphery, five flattenings 8, for example, are provided for the fuel to flow past.

The fuel injector is actuated in a known manner, e.g. electromagnetically. A schematically indicated electromagnetic circuit having a solenoid coil 10, an armature 11 and a core 12 is used for axially moving valve needle 5 and, as such, for opening the injector against the spring force of a restoring spring (not shown) and for closing the injector. Armature 11 is connected to the end of valve needle 5 facing away from valve-closure member 7 by, for example, a welded seam formed by a laser, and is aligned with core 12.

A guide opening 15 of a valve-seat member 16, which is sealingly mounted by welding into the downstream end of valve-seat support 1 facing away from core 12, in longitudinal opening 3 running concentrically with respect to longitudinal valve axis 2, is used for guiding valve-closure member 7 during the axial movement. At its lower end face 17 facing away from valve-closure member 7, valve-seat member 16 is concentrically and securely joined to a, for instance, cup-shaped apertured disk 20. Apertured disk 20 is implemented with a base part 24 and a retention rim 26. Retention rim 26 extends in the axial direction facing away from valve-seat member 16, and is bent outwardly in conical fashion up to its end. Valve-seat member 16 and apertured disk 20 are joined, e.g., by a first peripheral and impervious welded seam 25, formed by a laser, in an outer annular region of base part 24. For reasons of fatigue strength of the injector, apertured disk 20 should have a thickness of at least 0.2 mm in this securing region. In the region of retention rim 26, apertured disk 20 is moreover joined to the wall of longitudinal opening 3 in valve-seat support 1, e.g., by a peripheral and impervious second welded seam 30.

According to the present invention, a middle region 33 of base part 24 of apertured disk 20 is reduced in thickness compared to the outer annular region of base part 24 and compared to retention rim 26. At least one, however, ideally a plurality of spray-discharge openings 34, is introduced in this middle region 33. In this context, spray-discharge openings 34 are advantageously located in the outer edge region of thickness-reduced middle region 33, which, for example, is circular, so that lower end face 17 of valve-seat member 16 covers spray-discharge openings 34, which means downstream of valve seat 29 between an outlet orifice 31 in valve-seat member 16 and spray-discharge openings 34 in apertured disk 20, in each case the fuel flow takes an S-shaped course.

The insertion depth of the valve-seat part, made up of valve-seat member 16 and cup-shaped apertured disk 20, into longitudinal opening 3 determines the size of the lift of valve needle 5, since the one end position of valve needle 5 when solenoid coil 10 is not energized is determined by the contact of valve-closure member 7 against valve seat 29 of valve-seat member 16, valve seat 29 tapering conically downstream. When solenoid coil 10 is energized, the other end position of valve needle 5 is determined, e.g., by the seating of armature 11 on core 12. Therefore, the path between these two end positions of valve needle 5 represents the lift. Valve-closure member 7 cooperates with valve seat 29.

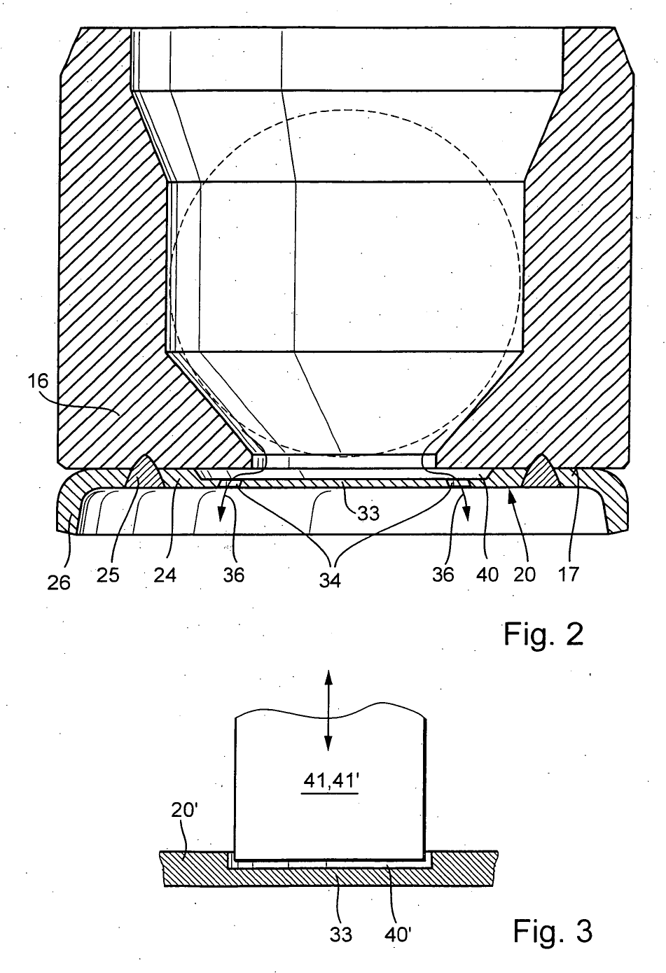

Valve-seat member 16 is formed with its lower outlet orifice 31 in such a way that lower end face 17 of valve-seat member 16 partially forms an upper covering of an intake region 40 of apertured disk 20, formed by the depression in middle region 33 of apertured disk 20, and thus determines the entry area of fuel into apertured disk 20. In the exemplary embodiment shown in FIG. 1, outlet orifice 31 has a smaller diameter than the diameter of an imaginary circle on which spray-discharge openings 34 of apertured disk 20 are situated. Because of the radial displacement of spray-discharge openings 34 with respect to outlet orifice 31, an S-shaped flow pattern of the medium, here the fuel, results toward each individual spray-discharge opening 34, which is indicated clearly in FIG. 2 by arrows 36.

The so-called S-twist within apertured disk 20 having several sharp reroutings of the flow impresses a strong, atomization-promoting turbulence on the flow. The velocity gradient transversly to the flow is thereby particularly strongly pronounced. It is an expression for the change in velocity transversely to the flow, the velocity in the middle of the flow being perceptibly greater than in the vicinity of the walls. The increased shear stresses in the fluid resulting from the velocity differences promote the disintegration into fine droplets near spray-discharge openings 34. Since because of the impressed radial component, the flow in the outlet is detached on one side, it experiences no calming because there is a lack of contour guidance. The fluid exhibits an especially high velocity at the detached side. The atomization-promoting turbulences and shear stresses are therefore not dissipated in the outlet. Due to the S-twist, a high-frequency turbulence is generated in the fluid, this turbulence causing the jet to disintegrate into suitably fine droplets immediately after exiting apertured disk 20.

FIG. 2 shows an enlarged representation of the valve part formed by valve-seat member 16 and apertured disk 20, in order to clearly indicate the S-shaped flow pattern, denoted by arrows 36, toward each spray-discharge opening 34. FIG. 3 shows schematically the impression method step.

In a first method step, not shown, a flat metallic sheet 20′ having a constant thickness is made available. This sheet 20′ has a thickness of approximately 0.2 mm, for example, which is retained outside of region 33 even after application of the method steps according to the present invention. For instance, sheet 20′ is a stainless steel material such as 1.4404, 1.4301 or SUS304, having a tensile strength of 500 to 700 N/mm² and an original hardness of 160±15 HV. For reasons of long-term endurance of the fuel injector, apertured disk 20 should have a minimum thickness of 0.2 mm at least in its annular region of base part 24, in which apertured disk 20 is secured to valve-seat member 16 by welded seam 25. In order to optimally adhere to the ratio of length to diameter of each individual spray-discharge opening 34 from the standpoint of fluid mechanics, given the predefined minimum thickness, the spray-orifice diameters are likewise largely predefined with a minimum value. If, for reasons of improved atomization and spray conditioning, a plurality of spray-discharge openings 34 having very small spray-orifice diameters, e.g. less than 0.2 mm, is now to be formed in apertured disk 20, it is advantageous in region 33 of spray-discharge openings 34, to reduce the thickness of sheet 20′, from which the later apertured disk 20 is formed.

In a further method step, thickness is reduced by impressing, a depression 40′ thereby being formed in sheet 20′ (FIG. 3). This depression 40′ has, for example, a frustoconically inclined or cylindrical limiting wall. Given an original thickness of sheet 20′ of 0.12 mm to 0.25 mm, the thickness reduction in region 33, accomplished by impressing, may amount to approximately 0.05 mm to 0.1 mm. A stamping tool 41 is indicated symbolically in FIG. 3. During the impressing process, a plastic deformation is carried out and material of sheet 20′ is displaced and piled up a little bit on the contact side of stamping tool 41 around depression 40′. This displaced material can easily be distributed in a rolling process. By this rolling or method also called “stamping”, the mound around impressed region 33 is uniformly distributed radially outwardly, resulting in a negligible increase in thickness in the region immediately outside of impressed region 33.

As an alternative to impressing, the thickness of sheet 20′ may also be reduced in region 33, in which spray-discharge openings 34 are located, by so-called embossing. It is a stamping-bending operation, similar to deep drawing, as a further possibility for cold-working a metal. Embossing is suitable for forming intake region 40 of apertured disk 20 in particular when the hardness of the material to be deformed is greater or considerably greater than 160 HV. During the embossing process, material is pushed out on the bottom side of sheet 20′ facing away from the contact side of embossing tool 41′. This protruding material is subsequently removed again by grinding, for example, so that the bottom side of sheet 20′, i.e., of apertured disk 20, is even.

After thickness has been reduced by impressing or embossing, in a further method step, the at least one spray-discharge opening 34 is introduced in region 33 of sheet 20′. Sheet 20′ is thereupon finish-machined until apertured disk 20 is obtained with its predefined outside dimensions. However, apertured disk 20 may also already be provided with the desired outside dimensions prior to introducing spray-discharge openings 34 by separating it from sheet 20′, for example, by punching out, cutting out, or in a similar manner. The at least one spray-discharge opening 34 is introduced by punching, eroding or laser drilling.

As already described in detail above, in conclusion, apertured disk 20 is secured according to the present invention in a manner that the flow approaches spray-discharge openings 34 in an S-shape, since in the mounted state of apertured disk 20, material of valve-seat member 16 overlaps spray-discharge openings 34 radially inwardly.

FIG. 1 shows, by way of example, a cup-shaped apertured disk 20, mounted on a fuel injector, which, because of its retention rim 26, is able to be mounted in a particularly secure and reliable manner. However, the method steps of the present invention for producing an apertured disk 20 are by no means limited to such geometrical designs of apertured disks 20. Rather, apertured disks 20 which are completely flat or bent differently are also able to be reduced in thickness according to the present invention in a region 33.

1-7. (canceled)

8. A method for producing and securing an apertured disk for a fuel injector for a fuel-injection system of an internal combustion engine, the apertured disk having an opening contour which ensures a complete passage of a fluid, the method comprising:
a) providing a flat, metallic sheet having a constant thickness;
b) reducing a thickness in one region of the sheet by one of impressing and embossing;
c) introducing at least one spray-discharge opening in the region having reduced thickness;
d) machining the sheet until an apertured disk having predefined outside dimensions is attained; and
e) securing the apertured disk on a valve-seat member of the fuel injector in such a way that a lower end face of the valve-seat member overlaps an intake region of the apertured disk produced by the thickness reduction, such that the at least one spray-discharge opening is covered.

9. The method according to claim 8, wherein the sheet provided for the impressing is made of a material having a tensile strength of 500 to 700 N/mm² and a hardness of 160±15 HV.

10. The method according to claim 8, wherein a material thrown up by the impressing on a contact side of a stamping tool is distributed on the sheet by rolling.

11. The method according to claim 8, wherein the sheet provided for the embossing is made of a material having a hardness greater than 160 HV.

12. The method according to claim 8, wherein a material pushed out by the embossing on a bottom side of the sheet facing away from a contact side of an embossing tool is removed by grinding.

13. The method according to claim 8, wherein the thickness is reduced in the region by 0.05 mm to 0.1 mm with the aid of one of impressing and embossing.

14. The method according to claim 8, wherein the at least one spray-discharge opening is introduced by one of punching, eroding and laser drilling.
